(19) United States
(12) Patent Application Publication
(10) Pub. No.: US 2026/0049794 A1
(43) Pub. Date: Feb. 19, 2026

(54) BALLISTIC SHIELD LIGHT SYSTEM

(71) Applicant: Sean McShea, Queen Creek, AZ (US)

(72) Inventor: Sean McShea, Queen Creek, AZ (US)

(21) Appl. No.: 19/303,836

(22) Filed: Aug. 19, 2025

Related U.S. Application Data
(60) Provisional application No. 63/684,769, filed on Aug. 19, 2024.

(51) Int. Cl. F41H 5/08; F21V 23/04; F21V 33/00

(52) U.S. Cl. CPC F41H 5/08; F21V 23/04; F21V 33/0064

(57) ABSTRACT

A ballistic shield light system designed for mounting on ballistic shields comprises a front portion with removably coupled inner and outer frames, a back portion with a removably attached power source, and a spacer element that couples the front and back portions while defining an operational gap. The system incorporates a high-intensity light source housed within the frame assembly and electrically connected to a power source. A remote control unit provides wireless or wired operation of the lighting system, featuring multiple operational modes including steady on, momentary on, and variable dimming capabilities. The system utilizes mechanical clamps and hook-and-loop fasteners for secure attachment to the ballistic shield's handle and body portions.

### CROSS REFERENCE TO RELATED APPLICATIONS

This application claims benefit from currently pending U.S. Provisional Application No. 63/684,769 titled “Ballistic Shield Light System” and having a filing date of Aug. 19, 2024, all of which is incorporated by reference herein.

### FIELD OF THE INVENTION

The present invention relates generally to lighting systems for tactical equipment, and more particularly to an integrated lighting system specifically designed for mounting on ballistic shields used by law enforcement, military personnel, and security professionals.

### BACKGROUND OF THE INVENTION

Ballistic shields are critical protective equipment widely used by law enforcement officers, military personnel, and security professionals during tactical operations, riot control, and high-risk situations. These shields typically comprise a protective shield portion made from ballistic-resistant materials and a handle portion that allows the operator to maneuver and position the shield effectively. During tactical operations, particularly in low-light environments such as building searches, nighttime operations, or poorly illuminated areas, operators require adequate illumination to maintain situational awareness, identify threats, and safely navigate their environment. Traditionally, operators have relied on handheld flashlights, weapon-mounted lights, or helmet-mounted lighting systems to provide necessary illumination.

However, existing lighting solutions present several significant limitations when used in conjunction with ballistic shields. Handheld flashlights require the operator to use one hand for lighting, reducing their ability to properly control the ballistic shield or access other equipment. This limitation is particularly problematic because proper ballistic shield deployment typically requires two-handed operation for optimal protection and maneuverability. Weapon-mounted lights, while useful in some tactical situations, may not provide optimal illumination angles when the operator is positioned behind a ballistic shield, as the weapon and shield may be oriented differently depending on the tactical situation. Additionally, weapon-mounted lights may create unwanted shadows or blind spots that could compromise the operator's safety. Helmet-mounted lighting systems, though providing hands-free operation, often fail to illuminate the area directly in front of the ballistic shield effectively. The angle and position of helmet-mounted lights typically result in inadequate illumination of the immediate area that the operator needs to observe through or around the shield.

Furthermore, existing lighting solutions are generally not designed to integrate seamlessly with ballistic shield equipment. Aftermarket mounting solutions are often inadequate, unreliable, or may compromise the structural integrity of the shield. Many existing mounting systems are not sufficiently robust to withstand the physical demands of tactical operations, including impacts, vibrations, and environmental conditions. Another significant limitation of current solutions is inadequate power management and control systems. Operators often require different lighting modes depending on the tactical situation, such as steady illumination for extended operations, momentary activation for brief illumination needs, or variable intensity to adapt to different environmental conditions. Existing lighting systems typically lack sophisticated control options that can be easily accessed while maintaining proper shield control.

Additionally, many current lighting solutions add excessive weight or bulk to the ballistic shield system, potentially compromising the operator's mobility, endurance, and tactical effectiveness. The additional weight can cause operator fatigue during extended operations and may affect the balance and handling characteristics of the shield. Power source limitations also present challenges in existing systems. Many portable lighting solutions have insufficient battery capacity for extended tactical operations, requiring frequent battery changes or recharging. This limitation can compromise operational readiness and may leave operators without adequate illumination during critical moments. Moreover, existing mounting systems often interfere with the normal operation and storage of ballistic shields. Many aftermarket lighting attachments are not easily removable, making shield maintenance, transport, and storage more difficult. Some mounting systems may also interfere with the operator's grip on the handle or their ability to position the shield effectively.

Therefore, there is a need for ballistic shield light system that is easy to install and easily adjustable to the shield and has enhanced control mechanisms to provide users with the capability to adjust light intensity, color, and operational modes seamlessly and without distraction from their critical tasks.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

U.S. Pat. No. 10,288,387

US Patent Application No. US20100284178

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c) (1)-(3), applicant(s) will amend the specification to expressly recite the essential material that is incorporated by reference as allowed by the applicable rules.

### SUMMARY OF THE INVENTION

This invention relates to a ballistic shield light system for mounting on a ballistic shield having a shield portion and a handle portion. The system comprises a front portion having an inner frame and an outer frame wherein the outer frame is removably coupled to the inner frame, a back portion having a power source removably coupled to it, and a spacer coupling the front portion to the back portion, wherein the front portion, the back portion, and the spacer define a gap.

The back portion further comprises a base member extending therefrom, the base member having bottom hole to which a clamp is rotatably coupled to. The clamp comprises a knob and a screw for secure attachment. The inner frame and the outer frame contain a light source that is coupled to the power source by at least one electrical connection. The system further comprises a control that is remotely coupled to the power source and/or the light source.

The back portion comprises at least one upper slot and at least one lower slot, and at least one hook and loop fastener is removably coupled to the at least one upper slot and the at least one lower slot. The power source is coupled to the back portion by the at least one hook and loop fastener. The power source is between 5,000 and 15,000 mAh, and the light source is between 2,000 and 7,5000 lumens. The front portion, back portion and spacer are manufactured from plastic, aluminum, carbon fiber, stainless steel or aluminum alloy.

The control is wirelessly or wired connected to the power source and/or light wherein the control is at least one switch that turns the light on/off and has at least two modes for the light source. The at least two modes are steady on, momentary on, and secondary mode/dimmer. The light portion, power source holder and mounting portion are manufactured from one piece or multiple pieces. The control has at least one button, PCB board, and control housing that attaches to a handle on the ballistics shield, and the control is coupled to the handle by hook and loop fastener.

The method of providing illumination on a ballistic shield comprises mounting a ballistic shield light system to a ballistic shield having a shield portion and a handle portion, removably coupling a power source to the back portion, electrically connecting a light source contained within the inner frame and outer frame to the power source, and activating the light source to provide illumination. The method further comprises attaching the ballistic shield light system to the ballistic shield by rotatably coupling a clamp to a base member extending from the back portion, wherein the clamp engages with the ballistic shield, remotely controlling the light source by operating a control that is wirelessly or wired connected to at least one of the power source and the light source, wherein the control includes at least one switch configured to turn the light source on and off, selecting between at least two operational modes for the light source using the control, wherein the at least two modes include steady on, momentary on, and a secondary mode with dimming capability, and securing the control to the handle portion of the ballistic shield using at least one hook and loop fastener, wherein the control includes at least one button, a PCB board, and a control housing configured to attach to the handle.

This integrated design provides tactical personnel with hands-free illumination while maintaining full control and maneuverability of their ballistic shield, ensuring optimal protection and situational awareness during low-light operations.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S. C. § 112(f). Thus, the use of the words “function,” “means” or “step” in the Detailed Description or Description of the Drawings or claims is not intended to somehow indicate a desire to invoke the special provisions of 35 U.S. C. § 112(f), to define the invention. To the contrary, if the provisions of 35 U.S. C. § 112(f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S. C. § 112(f). Moreover, even if the provisions of 35 U.S. C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1 is an isometric back view of the ballistic shield light system in accordance to one, or more embodiments;

FIG. 2 is an isometric front view of the ballistic shield light system in accordance to one, or more embodiments;

FIG. 3a is a front view of the ballistic shield light system in accordance to one, or more embodiments;

FIG. 3b is a cross-sectional view of FIG. 3a of the ballistic shield light system in accordance to one, or more embodiments;

FIG. 4 is a back view of the ballistic shield light system in accordance to one, or more embodiments;

FIG. 5 is a side view of the ballistic shield light system in accordance to one, or more embodiments;

FIG. 6 is a top view of the ballistic shield light system in accordance to one, or more embodiments;

FIG. 7 is a bottom view of the ballistic shield light system in accordance to one, or more embodiments;

FIG. 8 is an isometric top front view of the ballistic shield light system in accordance to one, or more embodiments;

FIG. 9a is a front view of the ballistic shield light system in accordance to one, or more embodiments;

FIG. 9b is cross-sectional view of FIG. 9a of the ballistic shield light system in accordance to one, or more embodiments;

FIG. 10 is an isometric view of the ballistic shield light system light control in accordance to one, or more embodiments;

FIG. 11 is an isometric top view of the ballistic shield light system light control in accordance to one, or more embodiments;

FIG. 12 is an isometric front view of another embodiment of the ballistic shield light system in accordance to one, or more embodiments;

FIG. 13 is an isometric back view of another embodiment of the ballistic shield light system in accordance to one, or more embodiments;

FIG. 14 is a front view of another embodiment of the ballistic shield light system in accordance to one, or more embodiments;

FIG. 15a is a side view of another embodiment of the ballistic shield light system with a shield coupled to the system in accordance to one, or more embodiments;

FIG. 15b is a cross-sectional view of another embodiment of the ballistic shield light system with a shield coupled to the system in accordance to one, or more embodiments;

FIG. 16 is a front view of another embodiment of the ballistic shield light system in accordance to one, or more embodiments;

FIG. 17 is an isometric front exploded view of another embodiment of the ballistic shield light system in accordance to one, or more embodiments;

FIG. 18 is an isometric back exploded view of another embodiment of the ballistic shield light system in accordance to one, or more embodiments;

FIG. 19 is an isometric back view of another embodiment with power source installed of the ballistic shield light system in accordance to one, or more embodiments;

FIG. 20 is an isometric front view of another embodiment with light source installed of the ballistic shield light system in accordance to one, or more embodiments; and

FIG. 21 is an example cable assembly for the ballistic shield light system in accordance to one, or more embodiments.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

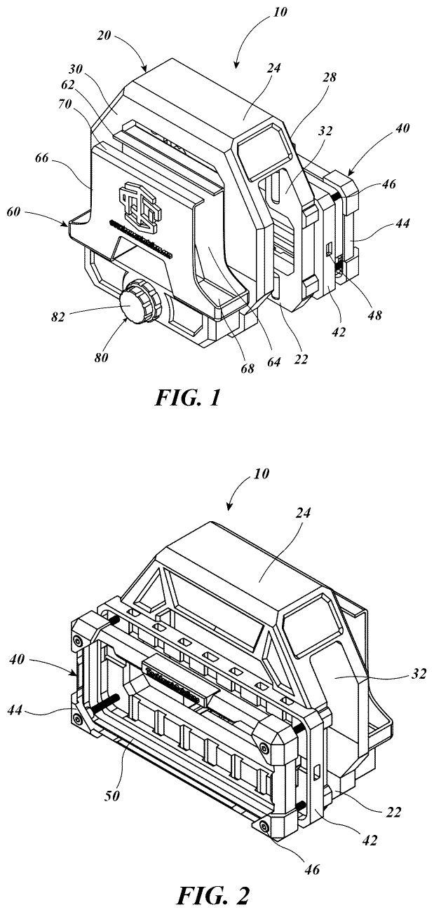

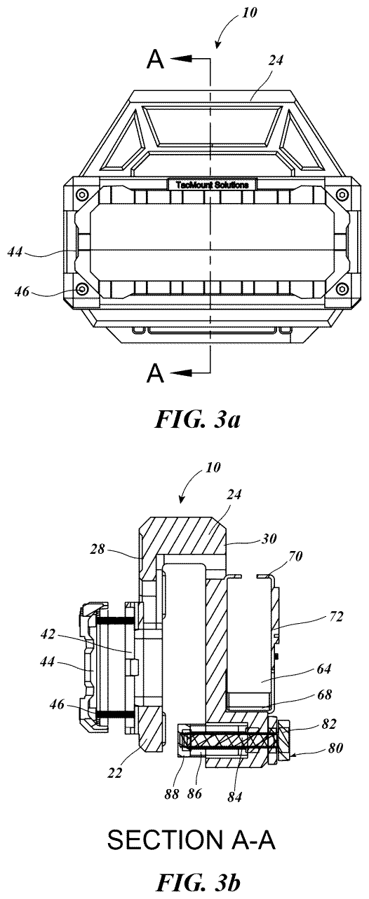

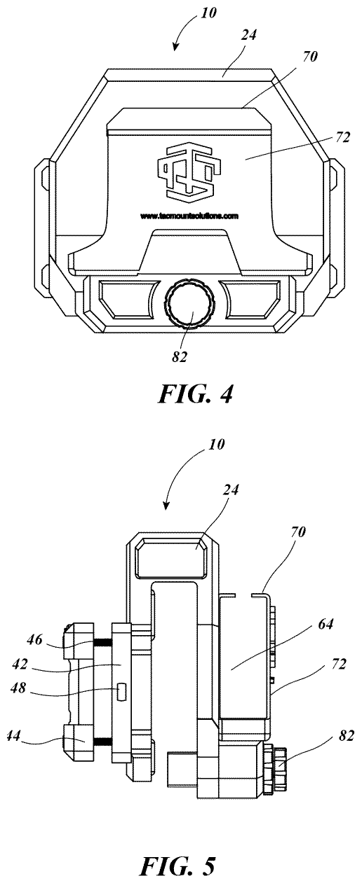

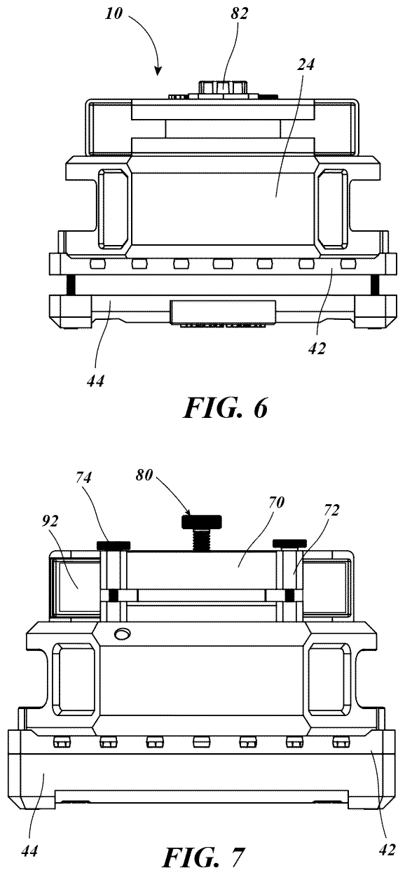

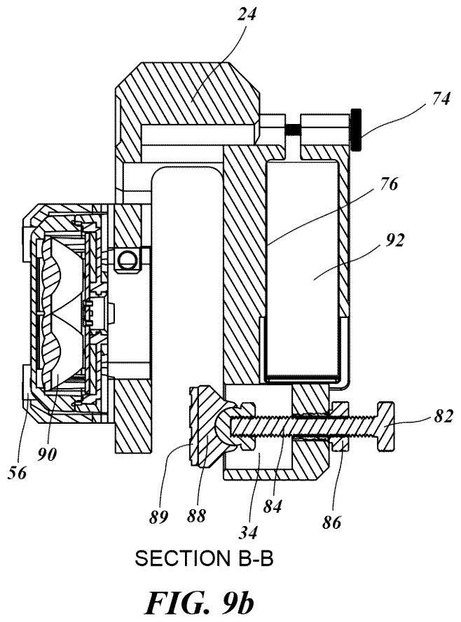

Referring initially to FIGS. 1-9b, a ballistic shield light system is shown generally at 10. In embodiments, the ballistic shield light system is shown generally at 10. The ballistic shield system 10 can comprise a mounting portion 20, a light holder 40, a power source holder 60 and a light remote 100. The ballistic shield light system 10 can be designed to provide illumination in low light or dark conditions and enhance the visibility and operational effectiveness of the user during tactical situations.

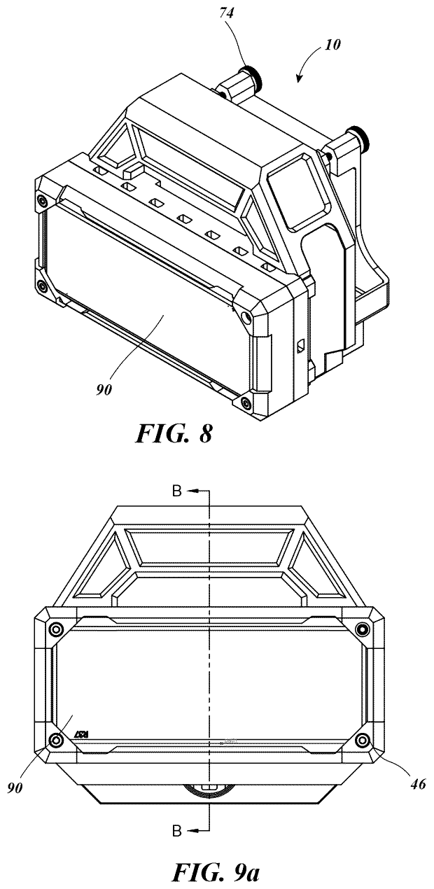

The light holder 40 can have an inner frame 42 and an outer frame 44 forming an inner light compartment 50. The outer frame 44 can be removably coupled to the inner frame 42 by at least one fastener 46. This design allows for easy assembly and disassembly of the light holder, facilitating maintenance and replacement of components when necessary. The light holder 40 can be any suitable shape and size to house a light source 90 as shown in FIG. 8. The inner frame 42 can have a port 48 for an electrical wire connection and/or power source connection or in other embodiments the light source 90 can be remotely controlled and have its own power source. In embodiments, the inner frame 42 can be removably coupled or permanently coupled to the mounting portion 20 wherein the inner frame and mounting portion can be two separate individual pieces or can be one complete molded piece. The at least one fastener 46 can be such as, for example, bolts, screws, pins, rivets, adhesive, weld, or the like. The inner frame 44 and the outer frame 44 can be such as, for example, rectangular, circular, square, polygonal, or the like in shape wherein the inner frame and the outer frame's light compartment 50 can accommodate any size and shape light source 90.

In embodiments, the outer frame can have an opening 54 on the outer frame's front side 52. The outer frame's opening 54 can be such as, for example, rectangular, circular, square, polygonal, or the like in shape to accommodate various size light sources 90. The outer frame 44 can have inner shelf 56 which can push the light source 90 against the inner frame. In certain embodiments the inner shelf 56 can have a padding such as, for example, polyurethane foam, memory foam, polyethylene foam, closed cell foam, open cell foam, or the like. The outer frame 44 can compress the light source onto the inner frame 42 with the fasteners allowing for varying thickness of light sources 90. The outer frame 44 can be such as, for example, machined, casted, molded, or the like out of such as, for example, plastic, stainless steel, aluminum, aluminum alloy, carbon fiber, ceramics, or the like. These materials are chosen for their strength, durability, and lightweight properties, ensuring the robustness and longevity of the light system.

In embodiments, the mounting portion 20 can have an open end 22 and a closed end 24 and a front side 28 and back side 30 forming a slot 32. The slot 32 can accommodate varying ballistic shield's thickness. Mounting portion 20 closed end 24 can be on the top of the mounting portion allowing the top or side of the ballistic shield to come into contact with or mate up to the closed end. The slot 32 can be a set length or in certain embodiments, the slot can be adjustable by such as, for example, rack and pinion, rails and set screws, or the like allowing the slot to adjust to varying thicknesses of different types of ballistics shield. In embodiments, the front side 28 and the back side 30 can be solid piece of material or can have sections cut out allowing for weight reduction. The mounting portion 30 closed end 24 can be any suitable shape, size or thickness, but in the preferred embodiment the closed end can be the shape or radius of the top of the ballistics shield allowing for the mounting portion to sit flush on the ballistics shield providing optimal support. In certain embodiments, the mounting portion 30 can sit on top of the shield, either side of the shield or bottom of the shield allowing the user to position the light source in the user's preferred positions on the ballistics shield. The mounting portion 30 can be made from such as, for example, plastic, stainless, aluminum alloy, aluminum, carbon fiber, ceramics, or the like.

In embodiments, the power source holder 60 can have at least one opening 62 which can allow for the insertion and removal of the power source 92. The power source 92 can provide the necessary energy to power the light source wherein the power source can be such as, for example, lithium-ion battery, nickel-metal hydride, alkaline battery, nickel cadmium battery, lead-acid battery or the like. The power source 92 can output such as, for example, 10 mAh to 50000mAh and more preferably 1000 mAh to 20000 mAh and still more preferably 12000 mAh. This capacity provides a long operational time, reducing the need for frequent recharging or replacement of the power source. The power source holder 60 can be coupled to the back side 30 of the mounting portion 20 or can be integral to the mounting portion wherein the power source holder can be made of the same or similar materials as the mounting portion.

The power source holder 60 can have at least one open side 66 wherein the top can be a partially open top 70, and a closed bottom 68. The power source holder 60 can clamp the power source between its power source back side 72 and power source front side 76. The power source front side 76 can be coupled to the back side of the mounting portion 20 or can be integral to the mounting portion. The power source back side 72 can have at least one tightening bolts 74 wherein the tightening bolts can clamp the power source between the power source front side 76 and the power source back side 72. The tightening bolts 74 can be such as, for example, thumb screws, wing screws, knurled head screws, hex head screws, captive screws, quick release pins, or the like. The tightening bolts 74 can spin freely on the power source back side and the power source front side 76 can have threads for the tightening bolts to engage and tighten the power source back side 72 to the power source front side 76. The power source holder 60 can be made from such as, for example, plastic, stainless steel, aluminum, carbon fiber, ceramics, or the like. The power source holder 60 design ensures the secure placement of the power source 92, preventing it from moving or falling out during use. The power source holder 60, light holder 40 and mounting portion 20 can be manufactured from one piece or multiple pieces, depending on the user's design requirements.

The ballistic shield light system can further comprise a clamp mechanism 80 which can be rotatably coupled to the power source holder 60. This design allows for the adjustment of the clamp mechanism, enabling the secure attachment of the light system to the ballistic shield. The clamping mechanism 80 can comprise a knob 82 that is rotatably coupled to the power source holder and/or a nut 86 wherein the nut is coupled to the power source back side 72 by such as, for example, press fit, threads, adhesive, bolts or the like. The knob 82 can be coupled to either separately or integral to a screw 84. The screw 84 can be such as, for example, acme screw, set screw, machine screw, clamping screw, t-screw of the like.

The screw 84 can be attached to a protective cover 88 which can be such as, for example, swivel level mount, ball and socket, articulated arm mount, gimbal mount, pivot mount, magnetic swivel mount, or the like. The protective cover 88 can have padding 89 on the end to protect the ballistics shield. The padding 89 can be such as, for example foam, closed foam, open foam, neoprene, or the like. The clamping mechanism can securely attach the ballistic shield light system 10 to the ballistics shield. This design ensures a secure and robust attachment of the light system to the ballistic shield, preventing accidental detachment during use. The mounting portion 30 can further have a recess 34 for the protective cover 88 to be recessed into while being removed from the ballistics shield.

The power source 92 can be coupled to the light source 90 by at least one electrical connection through the port 48 wherein the connection can be made through at least one wire or in other embodiments the electrical connection can be through a channel within the mounting portion and the power source can be connected by such as, for example, direct wiring, lead wires, battery clips and snaps, terminal block, connector plug, or the like. The power source 92 can be easily removed from the power source holder and connection reestablished when put back into the power source holder. This connection allows for the transfer of electrical energy from the power source to the light source, enabling the light source to emit light. This positioning of the light source ensures optimal illumination, providing a wide and evenly distributed beam of light.

The light source 90 can be such as, for example, 500 to 10000 lumens, and more preferably 1000 to 8000 lumens and still more preferably 2,000 to 5,000 lumens. This intensity provides a bright and powerful beam of light, enhancing visibility in low light or dark conditions. The light source 90 can be such as, for example, flood light, spotlight, angle down optics, or the like and can be light emitting diodes, high-intensity discharge, halogen, incandescent, plasma arc, or the like. These options provide a range of lighting characteristics, from the energy efficiency and long lifespan of LEDs to the intense brightness of HID lamps and the warm light of halogen and incandescent bulbs, catering to different illumination needs and preferences. The versatility in light source options allows for tailored solutions depending on the specific application, whether it be for broad area illumination or focused, intense beams of light.

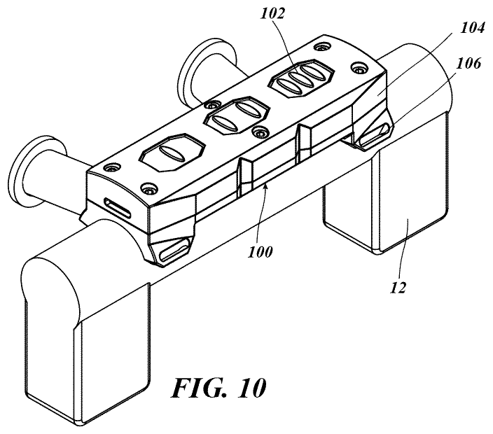

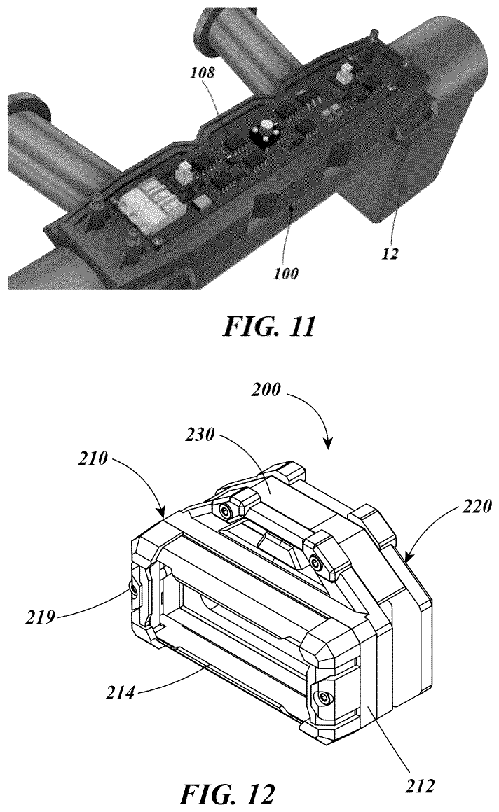

Referring to FIGS. 10-11, the ballistic shield light system 10 can further comprise a light remote 100 that can be remotely coupled to a shield handle 12 and to the power source 92 and/or light source 90 by such as for example, wired, Bluetooth, WiFi, or the like. The light remote 100 can comprises at least one button 102, a PCB board 108, and a control housing 104 that attaches to a handle of the ballistic shield. The light remote 100 allows the user to operate the light source 90 without having to physically touch the light system, enhancing operational convenience and safety. The light remote 100 can be wirelessly or wired connected to the power source and/or light source. The light remote 100 comprises a switch that turns the light on/off and has at least two modes for the light source which can be such as, for example, steady on, momentary on, secondary mode/dimmer or the like. The light remote 100 can be coupled to the ballistics handle by such as, for example, a hook and loop fastener, adhesive, bolts, rivets, clamps, or the like. This design allows for easy attachment and detachment of the control, facilitating operation and maintenance. The light remote 100 can allow the user to quickly change the settings of the light without having to remove their hand from the ballistics shield's grip.

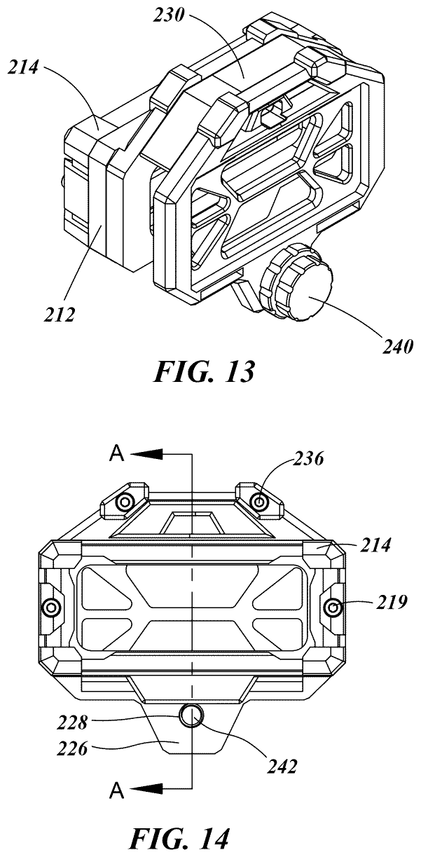

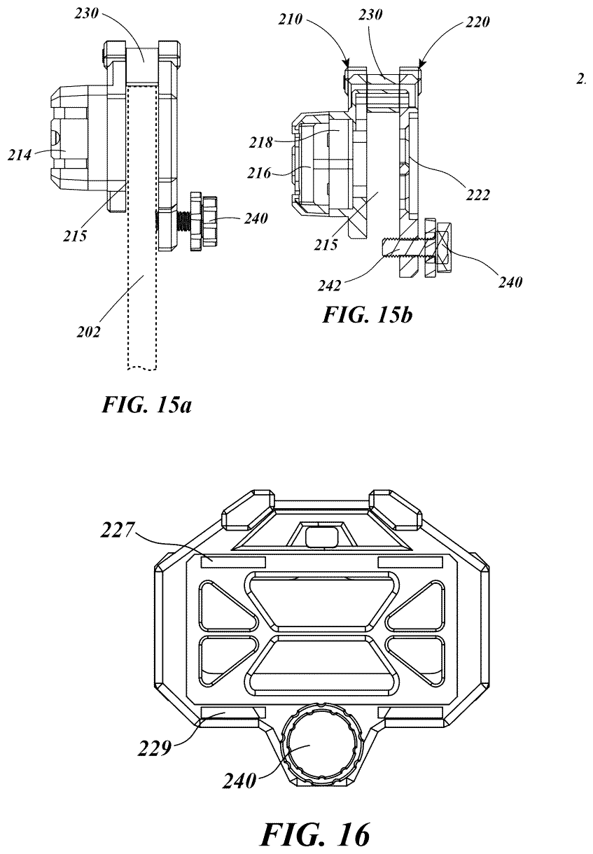

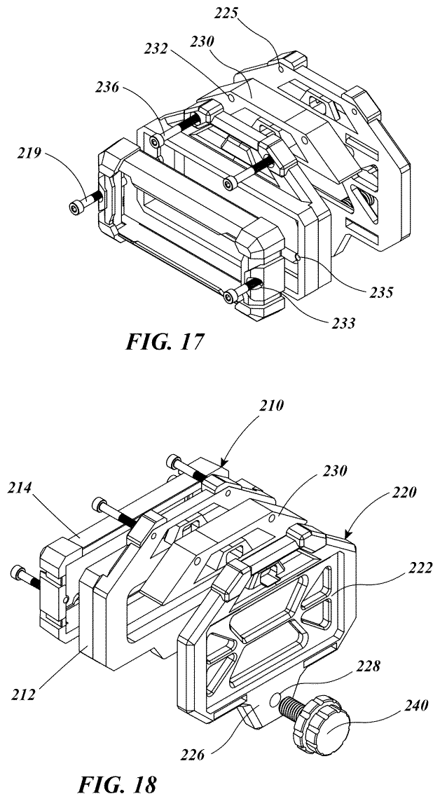

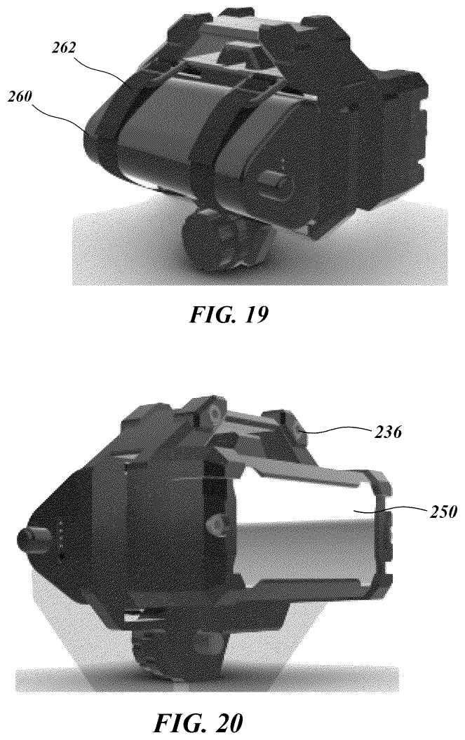

Referring to FIGS. 12-20 showing another embodiment of a ballistic shield light system 200. This system can have a front portion 210 consisting of an inner frame 212 and an outer frame 214, where the outer frame can be removably coupled to the inner frame through multiple attachment mechanisms. The inner frame 212 and outer frame 214 can be coupled together by various connection methods including such as, for example, at least one fastener 219, high-strength adhesives, precision-engineered snap-fit connections, or similar mechanical attachment systems. Both the inner frame 212 and outer frame 214 can be any suitable size and shape dimensioned to meet operational requirements. In the preferred embodiment, the inner frame 212 and outer frame 214 work in conjunction to securely capture and position a light source 250, which incorporates the same advanced illumination properties and technical specifications as the previously described light source 90.

In embodiments, the inner frame 212 and outer frame 214 assembly can have recesses that accommodate various light source configurations. The inner frame can have an inner recess 218, while the outer frame can have a corresponding outer recess 216. The inner recess 218 and the other recess 216 are dimensioned and engineered to accommodate a diverse range of light source 250 sizes and geometric profiles, providing flexibility for different operational requirements and allowing the light source to be securely seated within both the inner and outer recesses simultaneously. The inner frame 212 and the outer frame 214 can be coupled together by a threaded connection where the outer frame 214 features at least one strategically positioned fastener hole 233, which aligns with corresponding threaded holes 235 machined into the inner frame 212 therein the fastener 219 can create a secure, removable connection between the outer frame and inner frame components, ensuring proper alignment and load distribution while facilitating easy assembly and disassembly procedures. In other embodiments, the inner frame 212 and outer frame 214 can be one manufactured from one or multiple pieces.

The front portion 210 can be manufactured from a variety of materials such as, for example, engineered plastics for weight reduction, various metal alloys for enhanced strength, stainless steel for corrosion resistance and durability, advanced ceramic materials for superior ballistic protection, composite materials that combine multiple beneficial properties such as lightweight construction with enhanced protective capabilities, or the like. The material choice can be optimized based on specific operational requirements, environmental conditions, and performance specifications.

The system 200 can comprise a front portion 210 having an inner frame 212 and an outer frame 214 wherein the outer frame is removably coupled to the inner frame. The outer frame 214 can be coupled to the inner frame 212 by such as, for example, at least one fastener 219, adhesive, snap fit connections, or the like. The inner frame 212 and the outer frame 214 can be a suitable shape or size, but in the preferred embodiment the inner frame and outer frame can at least partially capture a light source 250 wherein the light source can have the same properties as stated above for lights source 90. The inner frame can have an inner recess 218 and the outer frame 214 can have an outer recess 216 that can be sized to accommodate a variety of light source 250 size and shape wherein the light source 250 can sit within the inner recess and the outer recess. The outer frame 214 can have at least one fastener hole 233 and the inner frame 212 can have at least one threaded hole 235 wherein the at least one fastener 219 can couple the outer frame to the inner frame. The front portion 210 can be made from such as, for example, plastic, metal, stainless steel, ceramic, composite, or the like.

In embodiments, the system 200 can have a back portion 220 which can have a power source 260 coupled to it, which can be securely coupled to provide electrical energy for the system's operation. A base member 226 can extend downwardly from the back portion 220, which can act as an intermediate structural component that facilitates the connection to additional hardware. This base member 226 can have a bottom hole 228 positioned in the base member which can serve as a mounting point for a clamp 240. The clamp 240 can be rotatably coupled to the bottom hole 228, allowing for adjustable positioning and secure fastening. The clamp 240 can be comprised of a knob 241 that can provide manual control for the user, and a screw 242 that generates the clamping force necessary for secure attachment of the system to the shield.

In certain embodiments, the screw 242 can be equipped with a protective cover that serves a dual purpose—it not only shields the screw mechanism from environmental damage and wear but also provides a cushioned interface that presses against the ballistic shield during operation. This protective cover can help distribute the clamping force evenly across the surface of the ballistic shield 202, preventing damage to the protective equipment while ensuring a stable and secure connection between the system and the shield assembly.

In embodiments the system 10, a spacer 230 can be a connecting element between the front portion 210 and the back portion 220. This spacer 230 functions as an intermediary structural component that maintains a predetermined spatial relationship between the front and back portions while simultaneously creating a defined gap 215 within the overall system architecture. The spacer 230 can be designed with considerable flexibility in terms of both geometric configuration and dimensional specifications. The spacer 230 can be manufactured in any suitable shape or size that meets the functional requirements of the particular application, whether that be such as, for example, cylindrical, rectangular, custom-contoured, or any other appropriate form factor. The spacer 230 can be variable thickness, wherein its dimensional properties can be adjusted or customized according to specific operational needs. This adjustability of the spacer 230 allows the end user to modify the spacer thickness to accommodate shields of varying dimensions, shapes and thicknesses that may be integrated into the system. By providing this adjustable thickness functionality, the spacer 230 ensures compatibility with a wide range of shield configurations while maintaining optimal gap spacing and overall system performance. The spacer 230 can be manufactured from such as, for example, plastic, metal, stainless steel, ceramic, composite or the like. The spacer 230 can be such as, for example, 0.125 to 3.5 inches thick and even more preferably 0.25 to 2 inches thick.

The spacer 230 couples the front portion 210 to the back portion 220, wherein the front portion, back portion, and spacer define a gap. The spacer 230 has at least one spacer hole 232 which allows the fastener 236 to couple the front portion 210 to the back portion 220. The back portion has back portion holes 225 which are threaded for the fasteners to couple to. The spacer hole 232 receives fastener 236, which extends through the spacer 230 to engage with the back portion holes 225 in the back portion 220. The threaded back portion holes 225 receive and retain the fasteners 236, creating a connection that maintains the gap between the front portion 210 and back portion 220. The fastener 236 and back portion holes 225 allow for disassembly and reassembly of the coupling between the front portion 210 and back portion 220. The threaded back portion holes 225 engage with fastener 236, preventing loosening during operation.

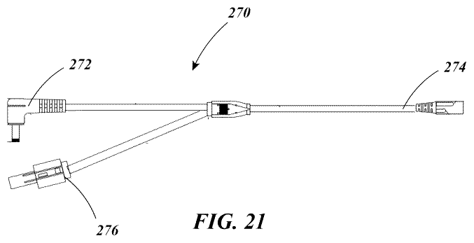

In embodiments, the back portion 220 of the device 10 can have at least one upper slot 227 and at least one lower slot 229 positioned on the back portion to accommodate coupling the power source 260 to the back portion. The power source 260 can be coupled by at least one hook and loop fastener that can be removably coupled to both the upper slot 227 and lower slot 229, creating a fastening system that securely holds the power source to the back portion of the device. The hook and loop fastener 262 can provide a strong hold during normal operation while allowing for quick removal when needed wherein this mounting approach enables users to easily replace the power source whenever it becomes depleted or experiences technical issues, eliminating the need for specialized tools or complex disassembly procedures. The at least one upper slot 227 and the at least one lower slot 229 can distribute the securing force evenly across the power source 260, preventing potential damage from concentrated stress points while ensuring the power source remains stable during device operation. This embodiment can enhance the device's maintainability and user experience by making power source replacement a simple process that can be completed quickly during routine maintenance procedures. The back portion 220 can be manufactured from such as, for example, plastic, metal, stainless steel, ceramic, composite or the like. In certain embodiments, the back portion 22 can have a slot 222 for the power source 260 to sit in Referring to FIG. 21, the system incorporates a cable assembly 270 that can establish an electrical connection between the power source components 260 or 92 and the light source elements 250 or 90 with the central light remote control unit 100. This multi-conductor cable assembly 270 features a sophisticated connector configuration that accommodates various source types and specifications within the lighting system. The cable 270 can have multiple dedicated connection points, each equipped with specialized connectors that are specifically matched to the electrical and mechanical requirements of their respective source components. For power source connections 260 or 92, the cable can have heavy-duty power connectors capable of handling the required voltage and current specifications. The power connectors can have contact materials and appropriate gauge wiring to ensure reliable power transmission and minimize voltage drop across the connection.

For light source integration, the cable assembly includes connectors designed to interface with the light source 250 or 90. These lighting connectors are configured to handle the specific electrical characteristics of LED, fluorescent, or other lighting technologies, incorporating features such as polarity protection and signal integrity preservation for advanced lighting control protocols. In certain embodiments, the cable 270 can have a connector identification system, allowing the light remote 100 to automatically recognize and configure appropriate control parameters for each connected source type. This adaptive connectivity ensures optimal performance across diverse lighting configurations while maintaining system compatibility and operational safety. The cable assembly 270 also includes appropriate shielding and conductor separation to prevent electromagnetic interference and ensure reliable signal transmission between all connected components. The ballistic shield light system 10 provides a robust, versatile, and convenient solution for providing illumination in low light or dark conditions. The system is designed for easy assembly and disassembly, facilitating maintenance and replacement of components. The system is also designed for secure attachment to a ballistic shield, enhancing operational effectiveness and safety. The system 10 further provides a remote control for convenient operation, and an adjustable power source holder for versatility in power source selection.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. A ballistic shield light system for mounting on a ballistic shield having a shield portion and a handle portion comprising:
a front portion having an inner frame and an outer frame wherein the outer frame is removably coupled to the inner frame;
a back portion having a power source removably coupled to it;
a spacer coupling the front portion to the back portion, wherein the front portion, the back portion, and the spacer define a gap.

2. The system of claim 1, wherein the back portion further comprises a base member extending therefrom, the base member having bottom hole to which a clamp is rotatably coupled to.

3. The system of claim 1, wherein the inner frame and the outer frame contain a light source that is coupled to the power source by at least one electrical connection.

4. The system of claim 3, further comprising a control that is remotely coupled to the power source and/or the light source.

5. The system of claim 1, wherein the back portion comprises at least one upper slot and at least one lower slot, and wherein at least one hook and loop fastener is removably coupled to the at least one upper slot and the at least one lower slot.

6. The system of claim 5, wherein the power source is coupled to the back portion by the at least one hook and loop fastener.

7. The system of claim 2, wherein the clamp comprises a knob and a screw.

8. The system of claim 1, wherein the power source is between 5,000 and 15,000 mAh.

9. The system of claim 1, wherein light source is between 2,000 and 7,5000 lumens.

10. The system of claim 1, wherein front portion, back portion and spacer are manufactured from plastic, aluminum, carbon fiber, stainless steel or aluminum alloy.

11. The ballistic shield light system of claim 4, wherein the control is wirelessly or wired connected to the power source and/or light wherein the control is at least one switch that turns the light on/off and has at least two modes for the light source.

12. The ballistic shield light system of claim 11, wherein the at least two modes are steady on, momentary on, and secondary mode/dimmer.

13. The ballistic shield light system of claim 10, wherein light portion, power source holder and mounting portion are manufactured from one piece or multiple pieces.

14. The ballistic shield light system of claim 3, wherein control has at least one button, PCB board, and control housing that attaches to a handle on the ballistics shield.

15. The ballistic shield light system of claim 14, wherein control is coupled to the handle by hook and loop fastener.

16. A method of providing illumination on a ballistic shield comprising:
mounting a ballistic shield light system to a ballistic shield having a shield portion and a handle portion, wherein the ballistic shield light system includes a front portion having an inner frame and an outer frame, a back portion, and a spacer coupling the front portion to the back portion;
removably coupling a power source to the back portion;
electrically connecting a light source contained within the inner frame and outer frame to the power source; and
activating the light source to provide illumination.

17. The method of claim 16, further comprising attaching the ballistic shield light system to the ballistic shield by rotatably coupling a clamp to a base member extending from the back portion, wherein the clamp engages with the ballistic shield.

18. The method of claim 16, further comprising remotely controlling the light source by operating a control that is wirelessly or wired connected to at least one of the power source and the light source, wherein the control includes at least one switch configured to turn the light source on and off.

19. The method of claim 18, further comprising selecting between at least two operational modes for the light source using the control, wherein the at least two modes include steady on, momentary on, and a secondary mode with dimming capability.

20. The method of claim 18, further comprising securing the control to the handle portion of the ballistic shield using at least one hook and loop fastener, wherein the control includes at least one button, a PCB board, and a control housing configured to attach to the handle.
